(19) United States
(12) Patent Application Publication
(10) Pub. No.: US 2017/0239915 A1
(43) Pub. Date: Aug. 24, 2017

(54) Peelable Coupon Containing Printable Water-Based Acrylic Pressure Sensitive Adhesive

(71) Applicant: BEMIS COMPANY, INC., Neenah, WI (US)

(72) Inventor: Jordan R. Tracy, Menasha, WI (US)

(21) Appl. No.: 15/515,466

(22) PCT Filed: Sep. 29, 2014
(86) PCT No.: PCT/US14/58063

§ 371 Date: Mar. 29, 2017

(51) Int. Cl. B32B 7/06; B32B 7/12; B32B 27/08; B32B 27/36; B65D 65/42; B32B 27/30; B65D 75/54; B65D 75/00; B65D 65/40; B32B 1/02; B32B 27/32

(52) U.S. Cl. CPC B32B 7/06; B32B 1/02; B32B 7/12; B32B 27/08; B32B 27/36; B32B 27/32; B32B 27/306; B65D 75/54; B65D 75/008; B65D 65/40; B65D 65/42; B32B 2250/24; B32B 2255/10; B32B 2255/26; B32B 2307/518; B32B 2307/7244; B32B 2307/748; B32B 2439/70; B65D 2575/586

(57) ABSTRACT

The present invention is directed to a packaging article configured as packaging rollstock comprising a multilayer laminate having an integrally formed peelable, removable coupon. The coupon is formed from a first layer having at least two score-lines and a pattern-applied second, third, fourth and fifth layer. The coupon includes an interior printable water-based acrylic pressure sensitive adhesive layer which advantageously provides a surface for printing graphics and resealability to packages made there-from.

### BACKGROUND OF THE INVENTION

The present invention relates generally to packaging articles and more particularly, to multilayer packaging laminates having an integrally formed peelable, removable coupon. The present invention also relates to packages and/or portions of packages incorporating the laminates having an integrally formed peelable, removable coupon.

Packaging is becoming more sophisticated to keep pace with promotional requests from marketers of products. There have been attempts to incorporate advertising and/or promotional items, such as coupons, stickers and game pieces, into a product's packaging. Store coupons or game pieces have been inserted as separate items in a package with promotional advertisements secured to the outside of the package. These coupons and game pieces are typically adhered to the outside of the package as labels. But with this technique, the store coupon or game piece may be removed by non-customers who remove the label without purchasing the product. To avoid these concerns and to encourage purchase of the product, coupons and game pieces have been incorporated into the packaging materials themselves.

### SUMMARY OF THE INVENTION

The present invention is directed to packaging articles having an integrally formed peelable, removable coupon. The article is formed from a multilayer laminate comprising a first layer having a first surface and a second surface, and comprising a first thermoplastic polymer. The first layer has at least two score-lines completely or partially through the thickness of this layer separated by a distance which defines the width of the coupon. The laminate also includes a second layer comprising indicia printed in a pattern on the second surface of the first layer; a third layer comprising a release coating printed in a pattern on the second layer; a fourth layer comprising a pressure sensitive adhesive printed in a pattern on the third layer; a fifth layer comprising indicia printed in a pattern on the fourth layer; the pattern encompassing; and a sixth layer having a first surface and a second surface; the sixth layer being in direct contact with the fifth layer.

An important aspect of the present invention is the use of a particular pressure sensitive adhesive in the formation of the laminate having an integrally formed peelable, removable coupon. The inventor has discovered that conventional printing inks may be printed on the surface of water-based acrylic pressure sensitive adhesives thereby providing a means for creating graphics on underlying layers of a multilayer laminate. A finding hitherto unknown in the art. A second important aspect of the present invention is the relative positioning of each of the patterns of the second, third, fourth and fifth layers of the laminate. The inventor has also discovered that by vertically aligning these patterns with the at least two score-lines provided in the first layer, a peelable coupon may be readily formed in the laminate. Once the coupon is removed, indicia reverse-printed on a transparent pressure sensitive adhesive layer is then revealed. Graphics that are printed on an outer layer of a coupon and would otherwise be removed with the coupon, can, in effect remain on the package by the printed image on the pressure sensitive adhesive layer because this layer remains intact with the laminate after the coupon is removed. Alternatively, graphics reverse-printed on a transparent pressure sensitive adhesive layer can be hidden underneath an opaque coupon and then can be revealed once the coupon is removed from the laminate. Thus, the present invention provides an improved packaging web having an integrally formed peelable, removable coupon for use in packaging food and non-food products. Advantageously, the present invention may be configured as packaging roll stock which is used in the construction of reclosable flexible packages having an integrally formed peelable, removable coupon.

### BRIEF DESCRIPTION OF THE DRAWINGS

Further features and advantages of the present invention will become apparent from the following detailed description, taken in combination with the appended drawings, in which:

FIG. 1a shows a schematic view of one preferred embodiment of a laminate illustrating the integrally formed peelable, removable coupon according to the present invention.

FIG. 1b shows a schematic view of one preferred embodiment of a laminate illustrating the integrally formed peelable, removable coupon partially removed from the laminate according to the present invention.

FIG. 1c shows a schematic view of one preferred embodiment of a laminate illustrating the integrally formed peelable, removable coupon completely removed from the laminate according to the present invention.

FIG. 2 shows a schematic view of another preferred embodiment of a laminate illustrating the integrally formed peelable, removable coupon according to the present invention.

FIG. 3 shows a schematic view of another embodiment of a laminate illustrating the integrally formed peelable, removable coupon according to the present invention.

FIG. 4 shows a schematic view of another embodiment of a laminate illustrating the integrally formed peelable, removable coupon according to the present invention.

FIG. 5 shows a schematic view of still another embodiment of a laminate illustrating the integrally formed peelable, removable coupon according to the present invention.

FIGS. 6a and 6b show isomeric views of another preferred embodiment of the present invention in the form of a stand-up pouch having hidden indicia revealed after removal of the integrally formed peelable, removable coupon.

FIGS. 7a and 7b show isomeric views of another preferred embodiment of the present invention in the form of a stand-up pouch having indicia reverse-printed on an interior transparent pressure sensitive adhesive layer which is revealed after removal of the integrally formed peelable, removable coupon.

### DETAILED DESCRIPTION OF THE INVENTION

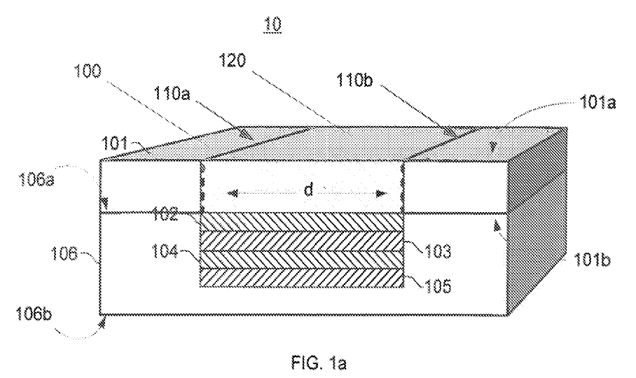

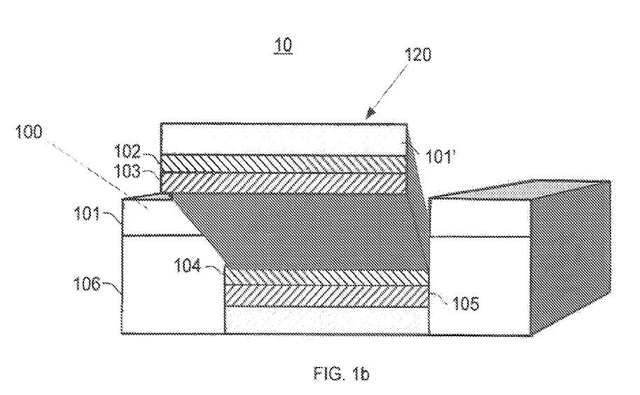

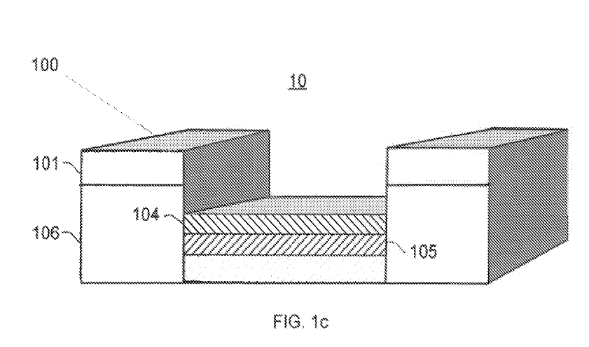

Referring now to FIGS. 1a-1c of the drawings, a preferred embodiment of packaging article 10 of the present invention having an integrally formed coupon 120 (see FIG. 1b) is shown. FIG. 1a depicts article 10 as a packaging laminate 100 having at least six layers. FIG. 1b depicts article 10 with coupon 120 being peelable removed from laminate 100. While FIG. 1c illustrates laminate 100 with coupon 120 completely removed.

Laminate 100 includes a first layer 101 having a first surface 101a and a second surface 101b, which comprises a thermoplastic material. Any thermoplastic material may be used to form this layer. Non-limiting examples of suitable thermoplastic materials include polyesters, such as aromatic polyesters, polyolefins, such as polypropylene and polyethylene, and polyamides. Particularly well-suited thermoplastics include uniaxially or biaxially oriented polyesters, uniaxially or biaxially oriented polyolefins and uniaxially or biaxially oriented polyamides. In one preferred embodiment, layer 101 includes a biaxially oriented polyethylene terephthalate (OPET). In another preferred embodiment, layer 101 comprises an oriented polypropylene (OPP). In still another preferred embodiment, layer 111 includes an oriented nylon, and more preferably, an oriented nylon 6.

Coupon 120 has a width and a length and is peelable and removable from laminate 100 as illustrated in FIGS. 1b and 1c. Two score-lines 110a and 110b are present in first layer 101 which may extend through the entire thickness of this layer or through less than the entire thickness of this layer. Score-lines 110a and 110b are separated by a distance d which defines the width of the coupon 120 (see FIG. 1a). The at least two score-lines may be formed by any mechanical and/or optical scoring, cutting or perforating methods known in the art. One example of a scoring technique which may be used to assist in the formation of perforations is optical ablation using a laser source. Laser scoring is well-known in the art. Score-lines may also be formed as continuous, intermittent or a combination of continuous and intermittent segments of scoring, cutting or perforations. In one preferred embodiment, score lines 101a and 101b each has a depth of the entire thickness of first layer 101. In another preferred embodiment, score lines 101a and 101b each has a depth of less than the entire thickness of first layer 101. In a preferred embodiment, the two score-lines comprise a pair of offsetting, parallel cuts in first layer 101. In still yet another embodiment, laminate 100 includes a second pair of score-lines as a pair of offsetting, parallel cuts (not shown). This second pair of score-lines is preferably disposed perpendicular to the first pair of offsetting, parallel cuts 101a and 101b.

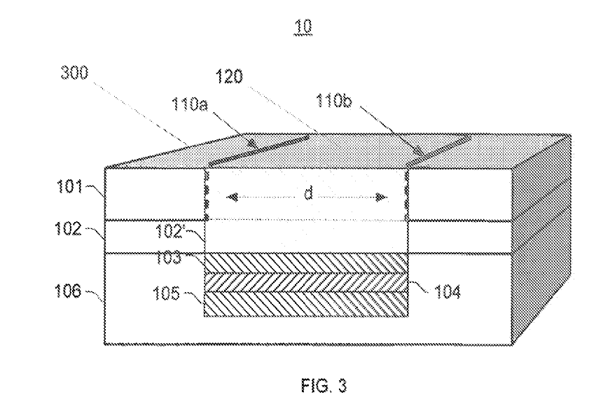

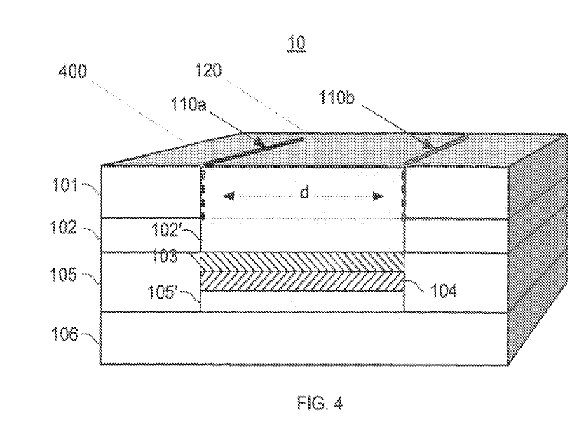

Further included in laminate 100 is a second layer 102 which comprises indicia printed in a pattern on the second surface of the first layer 101b. The pattern of second layer 102 encompasses at least an area which is vertically aligned with the width d of the coupon. In other preferred embodiments as illustrated for laminates 300, 400 and 500 in FIGS. 3, 4 and 5, respectively, second layer 102 is coextensive with first layer 101, but still includes at least an area 102′ which is vertically aligned with the width d of the coupon and is removed when coupon 120 is removed. Any conventional ink may be used in forming second layer 102. Laminate 10 also includes a third layer 103 comprising a release coating printed in a pattern on the second layer. Any conventional release agent may be used including, but not limited to a silicone, a release varnish, or a release lacquer. In one preferred embodiment, the release coating is specifically designed to be applied onto second layer 102 by rotogravure printing techniques. In another preferred embodiment, the release coating is specifically designed to be applied onto second layer 102 by flexographic printing techniques.

Laminate 100 also includes a third layer 103 comprising a release coating printed in a pattern on the second layer 102. The release coating may include, but is not limited to a silicone, a release varnish, a release lacquer or any other release agent. In several preferred embodiments as depicted for laminates 100, 200, 300, 400 and 500 in FIGS. 1a, and FIGS. 2-5, respectively, the third layer 103 is applied as a pattern contiguously on second layer 102 with the pattern encompassing an area which is vertically aligned with the width d of the coupon.

Laminate 100 further includes a fourth layer 104 comprising a water-based acrylic pressure sensitive adhesive (PSA) printed in a pattern on the third layer 103. Water-based or water-dispersible acrylic pressure sensitive adhesives are typically prepared by copolymerization with high amounts of various hydrophilic monomers. For example, acrylic ester copolymers with vinyl pyrrolidine yield water-dispersible PSAs. A copolymer of acrylic or methacrylic acid with an alkoxyalkyl ester, such as 2-ethoxyethyl acrylate, prepared by solution polymerization produces a water-soluble pressure sensitive adhesive. In certain instances, water-based acrylic PSAs can be made as emulsion adhesives. In one preferred embodiment, fourth layer 104 is a water-based acrylic pressure sensitive adhesive emulsion. In a preferred embodiment, the pattern of fourth layer 104 is applied by either flexographic or rotogravure printing methods. Examples of a commercially available water-based acrylic pressure sensitive adhesive emulsion include, but are not limited to those sold under the trademark family ROBOND™ by The Dow Chemical Company. Preferably, fourth layer 104 is printed in a pattern which is contiguous with third layer 103 as illustrated for laminates 100, 200, 300, 400 and 500 in FIGS. 1a, and FIGS. 2-5, respectively, where the pattern encompasses an area which is vertically aligned with the width d of coupon 120.

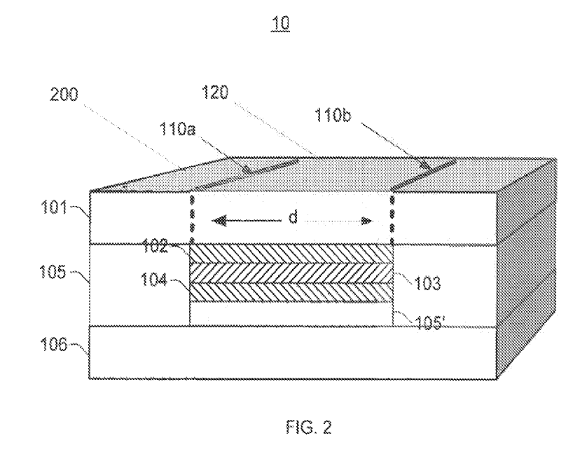

Printed in a pattern on fourth layer 104 is a fifth layer 105 which comprises indicia. In a preferred embodiment, the pattern of fifth layer 105 is applied by either flexographic or rotogravure printing methods. In some preferred embodiments, for example, laminates 100 and 300 as depicted in FIGS. 1a and 3, fifth layer 105 is contiguous with fourth layer 104 applied in a pattern which is vertically aligned with the width d of coupon 120. In other preferred embodiments, fifth layer 105 is coextensive with first layer 101 having the pattern of fifth layer 105 which encompasses an area 105′ that is vertically aligned with the width d of coupon 120 as illustrated for laminates 200, 400 and 500 in FIGS. 2, 4 and 5, respectively.

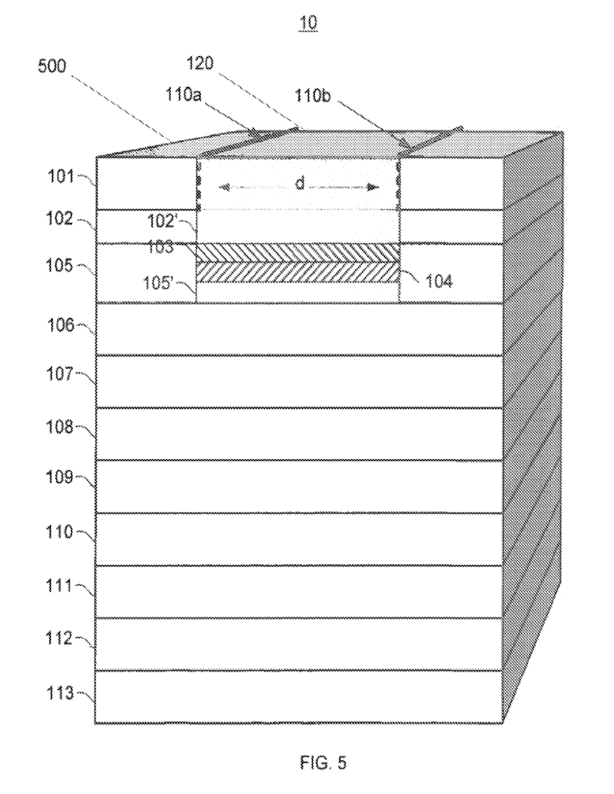

Laminate 100 further includes a sixth layer 106 which is in direct contact with fifth layer 105 and has a first surface 106a and a second surface 106b as depicted in FIG. 1a. Sixth layer 106 may include any thermoplastic or adhesive material which adheres to first layer 101 and fifth layer 105. For example, sixth layer 106 may be a capping layer with the first surface 106a in contact with first layer 101 and fifth layer 105 having no other layer in contact with the second surface 106b. In this embodiment, the capping layer may include a homopolymer or copolymer of polyester, polyamide or polyolefin. Alternatively, additional layers may be in contact with the second surface 106b of sixth layer 106. For example, sixth layer 106 may include a lamination adhesive material where a coextruded multilayer oxygen-barrier film is in contact with second surface 106b. The lamination adhesive may include, but is not limited to non-printable water-based acrylic emulsion adhesives and polyethylenes. Preferably, the non-printable water-based acrylic emulsion adhesive is a non-pressure sensitive adhesive. As illustrated for laminate 500 in FIG. 5, the coextruded multilayer oxygen-barrier film may include seven layers having at least one or more layers comprising an oxygen barrier material. This embodiment will be described in more detail herein below in Example 1.

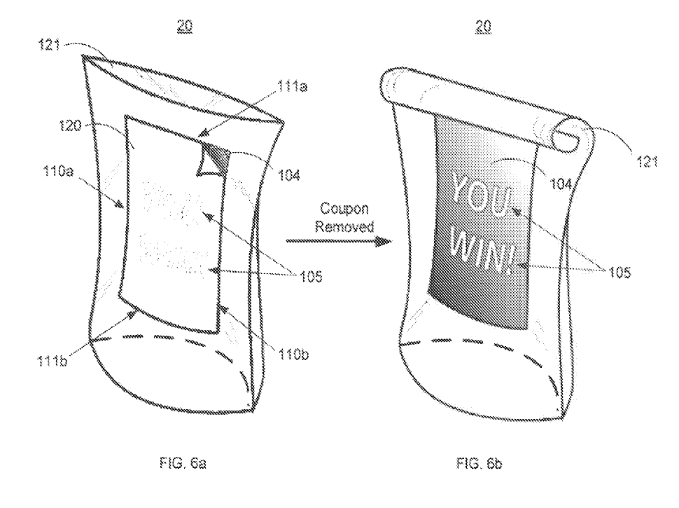

Turning now to FIGS. 6a and 6b there is illustrated one preferred embodiment of the present invention configured as a vertical stand-up pouch 20. Vertical stand-up pouches may be manufactured using vertical form-fill and seal packaging machines which are well-known in the art. Pouch 20 is formed from laminate 500 described and illustrated below. In the example depicted in FIG. 6a, package 20 is shown having an opened mouth 121 and a peelable, removable coupon 120 which is defined by a first pair of score-lines 110a and 110b, and a second pair of score-lines 111a and 111b with a corner edge peeled back. As can be seen, in this particular embodiment, each of the score-lines of the first pair, 110a and 110b are offsetting, parallel cuts of each other, as are each of the score-lines of the second pair, 111a and 111b. The first pair of score-lines is also disposed perpendicular to the second pair of score-lines. In this example, the second layer of opaque indicia 102 is printed on a first layer 101 which hides an opaque indicia layer 105 (indicated by dotted lines). Once the coupon is removed from the package as illustrated in FIG. 6b, the surface of pressure sensitive adhesive layer 104 is exposed. Because the pressure sensitive layer 104 is typically transparent, indicia layer 105 is now visible after coupon 120 is removed. Another advantage of the present invention is that once coupon 120 is removed and the pouch is opened, the pouch may be easily reclosed by folding and rolling a portion of opened mouth 121 over onto itself until it contacts the exposed surface of pressure sensitive adhesive 104 and becomes secured thereto.

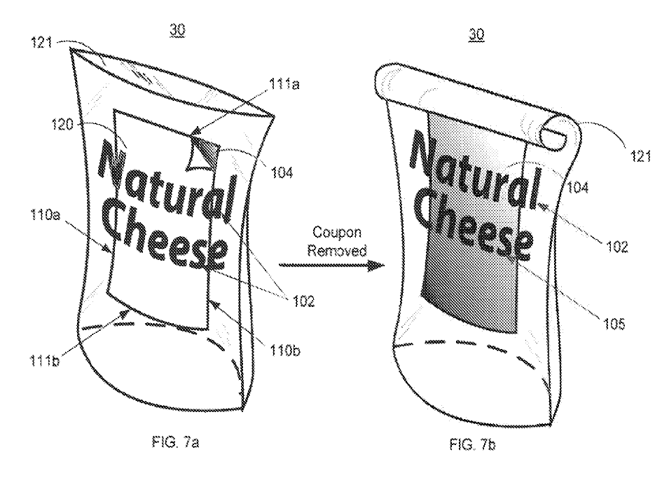

FIGS. 7a and 7b show isomeric views of another preferred embodiment of the present invention in the form of a stand-up pouch 30. Pouch 30 is also formed from laminate 500 described and illustrated below. As can be seen in FIG. 7a, the second layer of indicia 102 is clear and transparent printed on a first layer 101 (not shown). The fifth layer of an opaque indicia 105 printed on an interior transparent pressure sensitive adhesive layer 104 is visible before coupon 120 is removed because second layer 102, third layer 103 and fourth layer 104 are each transparent. In this embodiment, fifth layer of indicia 105 are graphics that remain on the package after coupon 120 is removed. Thus, graphics can, in effect, remain on the pouch by the printed image on interior pressure sensitive adhesive layer 104 because this layer readily accepts common printing inks and remains intact after coupon 120 is removed. As with pouch 20, pouch 30 may also be easily reclosed by folding and rolling a portion of opened mouth 121 over onto itself until it contacts the exposed surface of pressure sensitive adhesive 104 and becomes secured thereto.

It is also contemplated that further embodiments of the present invention may include other packaging formats such as, but not limited to horizontal stand-up pouches and pillow pouches, quad-seal packages, flow wrap packages and overwraps each of which having a peelable, removable coupon which when removed provides a means to reclose the package by folding the package over onto itself. Alternatively, the present invention may be configured as packaging roll stock which is used to form lidding film for rigid packages having a peelable, removable coupon.

### WORKING EXAMPLE

In the following example, laminate structure 500 as illustrated in FIG. 5 was produced using press lamination apparatuses, and methods which are well known to those skilled in the art. Prior to lamination, a first unitary film composed of first layer 101 was corona treated which was then printed with a second layer 102 (a first layer of indicia), followed by printing in register of a sequence of layers 103 (a layer of release coating), 104 (a layer of PSA) and 105 (a second layer of indicia), one on top of the other. A second unitary oxygen-barrier film composed of layers 107-113 was fabricated by blown film co-extrusion film apparatus and methods which are also well known in the art. The first and second unitary films were fabricated into a laminate by a press laminator using a lamination adhesive layer 106. After the laminate was fabricated, two score-lines were produced in the first layer 101 by use of laser ablation equipment and methods which are well-known to those skilled in the art.

### Example 1

Example 1 is one embodiment of laminate 500 of the present invention having a layer sequence (in the order as shown below) and layer compositions as described below and as illustrated in FIG. 5. Reported below is the layer composition relative to the total weight of the layer.
Layer 101: 100 wt.-% of a 92 gauge thick, corona treated biaxially oriented polyethylene terephthalate film (OPET)-SP65 (SKC, Inc., Covington, Ga., USA).
Layer 102: 100 wt.-% of clear, transparent ink.
Layer 103: 100 wt.-% of a release varnish-FSB B6DB (Sieg erk USA Company, Des Moines, Iowa, USA).
Layer 104: 100 wt.-% of a printable water-based acrylic pressure sensitive adhesive (PSA)-ROBOND™ PS-68 (The Dow Chemical Company, Midland, Mich., USA).
Layer 105: 100 wt.-% of colored, opaque ink.
Layer 106: 100 wt.-% of a water-based acrylic laminating adhesive-ROBOND™ L-90M (The Dow Chemical Company, Midland, Mich., USA).
Layer 107: 68.9 wt.-% of a linear low density polyethylene (LLDPE)-ExxonMobil™ LLDPE LL 1001.32 (ExxonMobil Chemical Company, Houston, Tex., USA)+30 wt.-% of a low density polyethylene (LDPE)-Petrothene® NA920 (Equistar Chemical, LP, Houston, Tex., USA)+1.1 wt.-% of processing additives.
Layer 108: 100 wt.-% of an anhydride modified polyethylene (mod-PE)-Bynel® 41E687 (E. I. du Pont de Nemours and Company, Wilmington, Del., USA).
Layer109: 100 wt.-% of an ethylene vinyl alcohol copolymer (EVOH)-Soarnol® ET3803 (Scams L.L.C., Arlington Heights, Ill., USA).
Layer 110: 100 wt.-% of an anhydride modified polyethylene (mod-PE)-Byner® 41E687 (E. I. du Pont de Nemours and Company, Wilmington, Del., USA).
Layer 111: 68.9 wt.-% of a linear low density polyethylene (LLDPE)-ExxonMobil™ LLDPE LL 1001.32 (ExxonMobil Chemical Company, Houston, Tex., USA)+30 wt.-% of a low density polyethylene (LOPE)-Petrothene® NA920 (Equistar Chemical, LP, Houston, Tex., USA)+1.1 wt.-% of processing additives.
Layer 112: 66.2 wt.-% of an ethylene alpha olefin copolymer (LLDPE)-Exact™ 3139 (ExxonMobil Chemical Company, Houston, Tex., USA)+20 wt.-% of a low density polyethylene (LDPE)-Petrothene® NA216-000 (Equistar Chemical, LP, Houston, Tex., USA)+13.8 wt.-% of polyethylene masterbatch of processing additives.
Layer 113: Same as Layer 112.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

1. A packaging article having an integrally formed peelable, removable coupon having a width and a length, the article comprising a multilayer laminate, the laminate comprising:
a first layer having a first surface and a second surface, and comprising a first thermoplastic polymer and at least two score-lines through the thickness of the first layer separated by a distance which defines the width of the coupon;
a second layer comprising indicia printed in a pattern on the second surface of the first layer; the pattern encompassing an area which is vertically aligned with the width of the coupon;
a third layer comprising a release coating printed in a pattern on the second layer; the pattern encompassing an area which is vertically aligned with the width of the coupon;
a fourth layer comprising a water-based acrylic pressure sensitive adhesive printed in a pattern on the third layer; the pattern encompassing an area which is vertically aligned with the width of the coupon;
a fifth layer comprising indicia printed in a pattern on the fourth layer; the pattern encompassing an area which is vertically aligned with the width of the coupon; and
a sixth layer having a first surface and a second surface; the sixth layer is in direct contact with both the first layer and the fifth layer.

2. An article according to claim 1, wherein the peelable coupon consists essentially of a portion of the first layer, a portion of the second layer, and a portion of the third layer wherein each portion of each layer includes an area having at least one dimension substantially equal to the distance separating the two score-lines of the first layer.

3. An article according to claim 1, wherein the article is a packaging web having a width and a length.

4. An article according to claim 3, wherein the length of the coupon is defined by the width of the packaging web.

5. An article according to claim 1, wherein the article is a package having a width and a length, and the length of the coupon is defined by either the width or the length of the package.

6. (canceled)

7. (canceled)

8. An article according to claim 5, wherein the package is a stand-up pouch, and is reclosable by removing the coupon and folding the width of the package upon itself such that it adheres to an exposed surface of the fourth layer.

9. An article according to claim 1, wherein the two score-lines comprise a pair of offsetting, parallel cuts,

10. An article according to claim 9, further comprising a second pair of offsetting, parallel cuts; wherein the first pair of cuts are perpendicular to the second pair of cuts.

11. (canceled)

12. An article according to claim 1, wherein the second layer is coextensive with the first layer.

13. An article according to claim 1, wherein the second layer is contiguous with the area defined by the width of the coupon.

14. An article according to claim 1, wherein the third layer is contiguous with the second layer.

15. An article according to claim , wherein the fourth layer is contiguous with the third layer.

16. An article according to claim 1, wherein the fifth layer is contiguous with the fourth layer.

17. An article according to claim 1, wherein the fifth layer is coextensive with the first layer.

18. An article according to claim 1, wherein the first thermoplastic polymer is a polyester, polyolefin or polyamide.

19. An article according to claim 18, wherein the polyester, polyolefin and polyamide are oriented.

20. (canceled)

21. (canceled)

22. (canceled)

23. (canceled)

24. (canceled)

25. (canceled)

26. (canceled)

27. (canceled)

28. (canceled)

29. An article according to claim 1, further comprising additional layers in direct contact with the second surface of the sixth layer.

30. An article according to claim 29, wherein the additional layers comprise a coextruded multilayer oxygen-barrier film.

31. An article according to claim 1, wherein the first surface of the first layer forms an exterior surface of the laminate.

32. An article according to claim 29, wherein the coextruded multilayer oxygen-barrier film comprises a heat sealable layer which forms an exterior surface of the laminate.
